(19) United States
(12) Patent Application Publication
(10) Pub. No.: US 2025/0209304 A1
(43) Pub. Date: Jun. 26, 2025

(54) WORKLOAD MANAGEMENT ENGINE IN AN ARTIFICIAL INTELLIGENCE SYSTEM

(71) Applicant: Microsoft Technology Licensing, LLC, Redmond, WA (US)

(72) Inventors: Shoham DEKEL, Tel Aviv (IL); Gilad PUNDAK, Rehovot (IL)

(21) Appl. No.: 18/390,634

(22) Filed: Dec. 20, 2023

(51) Int. Cl. G06N 3/045; G06N 3/082

(52) U.S. Cl. CPC G06N 3/045; G06N 3/082

(57) ABSTRACT

Methods, systems, and computer storage media for providing workload management using a workload management engine in an artificial intelligence (AI) system. In particular, workload management incorporates adaptive strategies that adjust the neural network models employed by a processing unit (e.g., NPU/GPU/TPU) based on the dynamic nature of workloads, workload management factors, and workload management logic. The workload management engine provides the workload management logic to support strategic decision-making for processor optimization. In operation, a plurality states of workload management factors are identified. A task associated with a workload processing unit is identified. Based on the task and the plurality of states of the workload processing unit, a neural network model from a plurality of neural network models is selected. The plurality of neural network models include a full neural network model and a reduced neural network model. The task is caused to be executed using the identified neural network model.

### BACKGROUND

Users rely on computing environments with applications and services to accomplish computing tasks. Users can interact with different types of applications and services that are supported by artificial intelligence (AI) systems. In particular, neural networks serve as versatile tools across numerous applications, leveraging their capacity to learn from data for predictive and decision-making tasks. Neural networks can refer to computational models associated with machine learning and artificial intelligence. Neural networks consist of interconnected nodes organized in layers (e.g., input layer, hidden layers, and output layer). By way of example, neural networks can support image and pattern recognition, assisting with tasks such as object detection, facial recognition, and image classification, influencing applications from security systems to photo tagging. And, in the field of natural language processing (NLP), neural networks power language translation, sentiment analysis, and chatbot interactions, facilitating human-like communication between machines and users.

### SUMMARY

Various aspects of the technology described herein are generally directed to systems, methods, and computer storage media for, among other things, providing workload management using a workload management engine of an artificial intelligence system. A workload management engine supports dynamically switching between different neural network models for optimized performance. In particular, workload management incorporates adaptive strategies that adjust the neural network models employed by a processing unit (e.g., neural processing unit “NPU”) based on the dynamic nature of workloads, workload management factors, and a workload management logic. The workload management engine includes the neural network models, workload management factors, workload management logic that support strategic decision-making for processing unit optimization.

The workload management engine operations include dynamically switching neural network models to optimize a processing unit's footprint to meet the overall system requirements of the processing unit. The neural network models (e.g., full neural network models and reduced neural network models) can be trained offline. The reduced neural network models can be generated using different reduction strategies (e.g., quantization, pruning, or network architecture selection “NAS”). The neural network models are deployed to support dynamically selecting them based on workload management factors (e.g., physical environment conditions, operational mode, power mode, power supply mode, and NPU capacity). The neural network models are also associated with workload management logic that instruct on which neural network model to employ based on identified workload management factors. Moreover, neural network models and tasks associated with the neural network models may further be associated with priority identifiers that are factored into a logic and decision to switch between neural network models.

Conventionally, artificial intelligence systems are not configured with a comprehensive computing logic and infrastructure to efficiently provide workload management for processing units (e.g., NPUs) of an artificial intelligence system. Un-optimized workload management for processing units can pose several drawbacks that may impact the overall performance, efficiency, and effectiveness of neural network processing. For example, a smart surveillance system can be deployed on a single device equipped with an NPU. This device is responsible for processing video feeds from multiple cameras and performing various computer vision tasks using different neural networks. The simultaneous operation of these neural networks (e.g., object detection neural network, facial recognition neural network, and anomaly detection neural network) on a shared NPU can lead to competition for computational resources. An un-optimized NPU can lack flexibility in adapting to diverse workloads, hindering their ability to handle a broad range of applications effectively causing suboptimal inference speeds, leading to delays in real-time processing tasks. Challenges in scalability, ineffective memory management, and difficulties in integration further contribute to their limitations.

A technical solution—to the limitations of conventional artificial intelligence systems—can include the challenge of implementing a workload management engine that supports an adaptive strategy framework; and the challenge of providing workload management operations and interfaces via a workload management engine in an artificial intelligence system. The adaptive strategy framework supports dynamically switching neural network models that are employed and evaluated to address various problems in a dynamic artificial intelligence system environment with a diverse processing unit workload. As such, the artificial intelligence system can be improved based on workload management operations that operate to effectively provide NPU workload management.

In operation, a plurality states of workload management factors are identified. A task associated with a workload processing unit is identified. Based on the task, the plurality of states of the workload management factors, and a workload management logic, a neural network model from a plurality of neural network models is selected. The workload management logic supports dynamically switching between the plurality of neural network models. The plurality of neural network models include a full neural network model and a reduced neural network model. The task is caused to be executed using the selected neural network model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary artificial intelligence system that includes a workload management engine that supports a first artificial intelligence client (edge device) and a second artificial intelligence client (cloud device), in accordance with aspects of the technology described herein;

FIG. 1B is a block diagram of an exemplary artificial intelligence client (edge device) with a workload manager of a workload management engine, in accordance with aspects of the technology described herein;

FIG. 2 is a block diagram of an exemplary schematic associated with a workload management engine, in accordance with aspects of the technology described herein;

FIG. 3 provides a first exemplary method of providing workload management using a workload management engine, in accordance with the technology described herein;

FIG. 4 provides a second exemplary method of providing workload management using a workload management engine, in accordance of the technology described herein;

FIG. 5 provides a third exemplary method of providing workload management using a workload management engine, in accordance with the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

An artificial intelligence system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to neural networks that are computational models associated with machine learning and artificial intelligence. Neural networks consist of interconnected nodes organized in layers (e.g., input layer, hidden layers, and output layer).

Artificial intelligence systems can include neural networks that serve as versatile tools across numerous applications, leveraging their capacity to learn from data for predictive and decision-making tasks. By way of example, neural networks can support image and pattern recognition, assisting with tasks such as object detection, facial recognition, and image classification, influencing applications from security systems to photo tagging. In the field of natural language processing (NLP), neural networks power language translation, sentiment analysis, and chatbot interactions, facilitating human-like communication between machines and users. Speech recognition systems rely on neural networks for transcription and voice-controlled functionalities, seen in virtual assistants and voice-operated devices. From healthcare applications, where neural networks aid in medical diagnosis by analyzing images and detecting anomalies, to the financial sector, where they contribute to fraud detection and stock price prediction, neural networks drive innovation and automation.

Computing power is becoming an important resource, especially with artificial intelligence (i.e., AI models) being employed to perform different types of tasks-some of which were not previously performed using AI models. An edge device (e.g., a surveillance system) can include several AI models that support providing surveillance functionality. For example, AI models can be associated with subsystems (e.g., camera, sensor) of the edge device; however, the AI models are optimized for performance without limitations of AI parameters-which can cause execution of AI tasks serially instead of simultaneously, which affects the speed at which AI tasks are performed. With these physical limitations (e.g., memory, battery state, processor capacity) and market demands for more AI implementation, the edge device needs performance improvements and management (e.g., processing unit optimization) to support the different AI models on the edge device. In particular, with the increasing use of AI models on processors that predate these models, it is critical to provide additional management and flexibility for running these AI models on the processors.

Conventionally, artificial intelligence systems are not configured with a comprehensive computing logic and infrastructure to efficiently provide workload management for processing units (e.g., NPUs) of an artificial intelligence system. Un-optimized workload management for processing units can pose several drawbacks that may impact the overall performance, efficiency, and effectiveness of neural network processing. For example, a smart surveillance system can be deployed on a single device equipped with an NPU. This device is responsible for processing video feeds from multiple cameras and performing various computer vision tasks using different neural networks. The simultaneous operation of these neural networks (e.g., object detection neural network, facial recognition neural network, and anomaly detection neural network) on a shared NPU can lead to competition for computational resources.

By way of illustration, all three neural networks can compete for the processing resources of the shared NPU. The object detection network requires real-time processing to track and identify objects, the facial recognition network demands precise computations to match faces accurately, and the anomaly detection network needs to continuously analyze the video streams for any abnormal patterns. The competition for the NPU's resources can lead to challenges such as increased inference latency, reduced overall throughput, and potential delays in responding to real-time events. An un-optimized NPUs can lack flexibility in adapting to diverse workloads, hindering their ability to handle a broad range of applications effectively causing suboptimal inference speeds, leading to delays in real-time processing tasks. As such, a more comprehensive artificial intelligence system—with an alternative basis for performing workload management operations—can improve computing operations and interfaces for workload management associated with processing units of neural network model workloads.

Embodiments of the present technical solution are directed to systems, methods, and computer storage media, for among other things, providing workload management using a workload management engine of an artificial intelligence system. A workload management engine supports dynamically switching between different neural network models for optimized performance. In particular, workload management incorporates adaptive strategies that adjust the neural network models employed by a processing unit (e.g., neural processing unit “NPU”) based on the dynamic nature of workloads, workload management factors, and a workload management logic. The workload management engine includes the neural network models, workload management factors, workload management logic that support strategic decision-making for processing unit optimization.

The workload management engine operations include dynamically switching neural network models to optimize a processing unit's footprint. The neural network models (e.g., full neural network models and reduced neural network models) can be trained offline. The reduced neural network models can be generated using different reduction strategies (e.g., quantization, pruning, or network architecture selection “NAS”). The neural network models are deployed to support dynamically selecting them based on workload management factors (e.g., physical environment conditions, operational mode, power mode, power supply mode, and NPU capacity). The neural network models are also associated with workload management logic that instruct on which neural network model to employ based on identified workload management factors. Moreover, neural network models and tasks associated with the neural network models may further be associated with priority identifiers that are factored into a logic and decision to switch between neural network models.

Workload management is provided using the workload management engine that is operationally integrated into the artificial intelligence system. The artificial intelligence system supports a workload management framework of computing components associated with dynamically switching between different neural network models for optimized performance. The use of NPU is meant to be exemplary, it is contemplated that other types of processing units (e.g., GPU/TPU/CPU) can be associated with implementation of the technical solution described.

At a high level, neural networks may have predefined footprints-often optimized for performance. The neural network footprint can refer to the resource and performance characteristics of the neural network. However, due to different operational factors of a processing unit (e.g., NPU/GPU/TPU) that supports the neural networks, all the neural networks cannot be optimized for performance. Balancing factors such as memory usage, computational efficiency, power consumption, and computational power with tradeoffs for performance can support optimizing operations of processing units. In particular, different reduction strategies (e.g., quantization, pruning, and network architecture selection) can be used to generate reduced neural network models with corresponding full neural network models; and based on issues experienced at the processing unit (e.g., runtime bottleneck, need to reduce power) an optimization logic is used to determine which reduced neural network model should be employed to perform tasks.

Processing units (or workload processing units), encompassing Neural Processing Units (NPUs), Graphics Processing Units (GPUs), and Tensor Processing Units (TPUs), are specialized hardware components designed to accelerate computational tasks in electronic devices. NPUs are tailored for neural network operations, efficiently executing parallelized tasks like matrix multiplication and tensor computations. GPUs, originally developed for graphics rendering, have evolved into powerful parallel processors adept at handling large-scale mathematical computations integral to neural network training and inference. They operate by concurrently processing multiple data points, making them particularly effective for parallelizable deep learning models. TPUs, support tensor computations and are optimized for both training and inference, providing high throughput and energy efficiency. The operational efficiency of these processing units is paramount in accelerating neural network workloads, with the choice dependent on factors such as task nature, scale, and overall performance requirements.

In operation, a particular application employing a first neural network model no longer primarily determines how to execute the first neural network model on a processor; instead a workload manager is provided to determine (e.g., based on tradeoffs and parameters) how to execute the first neural network model relative to a plurality of other neural network models and even for the particular user. For example, neural network models of a cell phone can executed via an optimized NPU based on assessing workload management factors (e.g., battery state, power mode, and physical conditions) and employing a workload management logic associated with the neural networks models to determine how to process tasks associated with the neural network models.

A high level flow can include a preparation phase and a runtime phase for workload management for a processing unit. The preparation phase can include training full neural network models and reduced neural network models. A full neural network refers to the complete architecture of a model, encompassing all its layers, nodes, and parameters as initially designed for a specific task. This could include intricate architectures like deep neural networks, convolutional neural networks (CNNs), or recurrent neural networks (RNNs), for example. Other types of neural works are contemplated with embodiments of the present technical solution.

On the other hand, a reduced neural network signifies a model that has undergone simplification or optimization processes to decrease its size, complexity, or computational demands. Reduction techniques may involve pruning connections or neurons, quantizing weights, employing knowledge distillation, or applying model compression methods. The choice between a full and a reduced neural network depends on the particular requirements of the application, with full networks providing high expressiveness and accuracy, while reduced networks offer advantages in computational efficiency and adaptability to resource-constrained environments. The decision involves balancing the trade-offs between model complexity, speed, and task performance.

The neural network models can be stored and deployed to support dynamically switching between neural network models. The neural network models can include first full neural network model associated with at least two corresponding reduced neural network models and a second full neural network model associated with at least two corresponding reduced neural network models. The neural network models can be employed in different types of scenarios including edge devices that may have limited computational power and memory, and require more energy efficiency. In this way, if an edge device needs to reduce power consumption or an NPU is at full computational capacity, a reduced neural network model can be employed.

The preparation phase can further include associating workload management factors (e.g., physical environment conditions, operational mode, power mode, battery state, power supply mode, processor active capacity, task priority, and neural network model priority) and workload management logic to different neural network models, such that, based on workload management factors, the workload management logic is used to determine identifying neural network models for a processing unit to perform a task. For example, a first full neural network model associated with audio noise cancellation can be a low priority neural network model, so the logic may indicate that the first full neural network model should be moved to a first reduced neural network model before a second full neural network model associated with surveillance detection that is a high priority neural network model is moved.

The runtime phase can include an initiation mechanism (e.g., event trigger, time loop, state change) that is used to call a trigger input associated with initiating the runtime phase. The runtime phase supports dynamically switching from a current neural network model to a selected subsequent neural network model. The trigger interrupt initiates selecting a subsequent neural network using a logic (i.e., workload management logic) associated with particular events and priority (i.e., workload management factors). For example, a smart surveillance system can be associated with physical environment conditions (e.g., day or night), operational mode (e.g., active, idle, power saving), battery state (e.g., low, medium, high) power supply (e.g., power connected, power disconnected), and NPU capacity (e.g., low, medium, high capacity). Workload management factors can be predefined factors (e.g., always on) that are established in advanced based on known criteria, specification, or predefined rules; and measured factors (e.g., power supply) are determined dynamically during operation real-time data or observations. The subsequent neural network model can be employed to execute a task associated with the NPU—to ideally optimize operations of the NPU.

A re-evaluation initiation mechanism (e.g., event trigger, time loop, state change) can be implemented to evaluate the subsequent neural network model that is currently active. The re-evaluation initiation mechanism initiates determining whether the subsequent neural network model is performing as expected (e.g., meeting a predefined performance threshold). In other words, the subsequent neural network model's perform is continuously or periodically monitored against quantified metrics, determining if it meets predefined performance thresholds. If subsequent neural network model meets or exceeds these thresholds, it is maintained.

A predefined performance threshold refers to a predetermined level or criterion that serves as a benchmark or standard against which the performance of a processor, a neural network model, or task is evaluated. This threshold is established based on specific requirements, expectations, or industry standards, and it represents the minimum acceptable level of performance. It can be defined across various metrics such as accuracy, speed, efficiency, or any other relevant performance indicator depending on the context. The purpose of setting a predefined performance threshold is to establish clear criteria for assessing the effectiveness, reliability, and suitability of the processor, neural network model, or task ensuring that it meets the desired standards and objectives. Exceeding or meeting these predefined thresholds is indicative of a successful and satisfactory performance, while falling below them may necessitate further optimization or improvement efforts.

By way of illustration, for image classification, a full neural network model, specifically a convolutional neural network (CNN) can be evaluated based accuracy, inference time, model size, and FLOPs (Floating Point Operations). Subsequently, a reduced neural network model that is derived through quantization—where the precision of parameters are reduced—is evaluated using the same metrics. The comparison of these metrics allows for a comprehensive assessment of trade-offs between the full and reduced models. This evaluation framework aids in selecting an optimized model tailored to the specific requirements of deployment scenarios, balancing computational efficiency with task performance.

In cases where the performance improvement of the subsequent neural network model is deemed insufficient, a determination can be made to return to the previous neural network model. Simultaneously, if returning to the previous neural network model is not considered beneficial, a second subsequent neural network model may be selected and implemented. This dynamic decision-making process ensures adaptability, allowing continuously optimization of the NPU performance based on real-time observations.

The dynamic decision-making process can be performed based on a workload management logic. Workload management logic for a processing unit (e.g., NPU) involves observing distinct workload management factors (e.g., physical environment condition, power mode, NPU capacity) associated with various neural network models (e.g., full neural network model, a first, a second, and a third reduced neural network model). Each neural network model possesses unique features—the first reduced neural network model is reduced based on quantization, the second reduced neural network model is reduced based on quantization, and the third reduced neural network model is reduced based on NAS.

By way of illustration, the workload management logic can include a decision matrix correlates the observed workload management factors with the characteristics of each neural network models. Example use cases include the following:
For an “always on device that requires power saving (efficiency)” use case, the logic is prompted to select a reduced neural network that can support basic detection without tracking;
for a “low battery state, power saving mode, power supply not connected” use case, the logic is prompted to select a reduced neural network model that is optimized for power and might have lower performance; and
for an “NPU at near-full computational capacity, and the NPU has requests to add one or more networks” the logic is prompted to select one or more reduced neural network models that are quantized, pruned, and optimized for memory.

The workload management logic incorporates adaptive thresholds and dynamic adjustments, allowing it to respond to real-time workload variations and refine decisions based on historical data. A feedback loop facilitates continuous learning, while a fallback mechanism ensures resilience by offering alternatives in case of unavailability or issues with any of the neural network models. Overall, this adaptive workload management logic optimizes resource utilization, enhances system performance, and accommodates evolving workload patterns.

The workload management logic can be a priority-aware logic for tasks associated with the NPU. The logic considers both workload management factors and the priority levels (e.g., critical, high, medium, low priority) associated with each task. For example, the previously described decision matrix can be extended to include task priorities establishing priority-aware decision rules that guide the selection process. For instance, “low battery state, power saving mode, power supply not connected device,” the logic is prompted to select a reduced neural network model that is optimized for power and might have lower performance-if the associated task has critical priority. The logic incorporates dynamic adjustments to task priorities, ensuring adaptability to changing circumstances. Integration of task queues and scheduling mechanisms allows for efficient execution based on task priorities and component availability. Fallback mechanisms are reinforced, providing redundancy for critical tasks to prevent disruptions. This priority-aware workload management logic optimizes resource allocation, adapts to shifting priorities, and enhances the overall efficiency of the system.

As such, the processing unit optimization can be based on different workload management factors. For each use case, where particular workload management factors are met, the workload management logic for the neural network models are applied to determine what to do. In particular, based on a states of workload management factors and workload management logic, a current neural network model can be switched to a subsequent neural network model (e.g., a reduced neural network model). If the subsequent neural network model operates at a predefined performance threshold, then the subsequent neural network model is used—or an attempt can be made to move to another subsequent neural network (e.g., another reduced neural network model smaller than the reduced neural network models).

The processing unit can be configured to support a plurality of neural network models, the plurality of neural network models are prioritized for optimization evaluation. As such, upon optimizing a first neural network model, a second neural network model—next in line based on prioritization—can be optimized next. It is contemplated that the NPU can be returned to normal operational mode based on a number of predefined conditions (e.g., timeout or change in one or more workload management conditions). For example, predefined conditions can include environment change (e.g., device movement with Inertial Movement Unit—IMU, change in light conditions, noise level change) or user change (e.g., presence detection reports a user is away, or change in a number of people in a scene).

Processing unit optimization can further be associated with additional optional extensions. An administrator user can be given prioritization control that includes providing the administrator user with the ability adjust the order or importance of various tasks, processes, or components of processing unit optimization to tailor processing unit optimization to their unique preferences and requirements. User prioritization control can also include prioritizing a particular user type. By way of illustration, user prioritization control can prioritize for accessibility users. A user may identify as an accessibility user, and based on this parameter, the workload management logic can indicate that neural network models should prioritize for accessibility associated with the accessibility user. In this way, the workload management logic can define a first set of decisions rules for accessibility users and a second set of decision rules for non-accessibility users.

Processing unit optimization can also include running a full neural network model and a reduced neural network model (e.g., quantized reduced neural network model) in parallel and comparing the outputs with a predefined comparison framework. The predefined comparison framework is used because different networks can have different criteria or parameters for evaluating strengths, weaknesses, features, and other relevant attributes. Evaluating the full neural network model and the reduced neural network in parallel is performed because, for example, in edge devices, full neural network models can support different sets of user; however, upon identifying a particular user in a set scenario, a reduced neural network model can be more efficient. Moreover, processing unit optimization can include continuous assessment of the performance of active neural network models to make determinations to dynamically switch to a subsequent neural network model. The processing unit optimization can also include running different sizes of neural networks interchangeably to continuously test differences or running different sizes of neural network interchangeably to reduce errors and provide more accurate results. Other variations and combinations of optional extensions are contemplated with embodiments of the present technical solution.

Advantageously, the embodiments of the present technical solution include several inventive features (e.g., operations, systems, engines, and components) associated with an artificial intelligence system having a workload management engine. The workload management engine supports workload management operations used to implement dynamically switching between different neural network models for optimized performance—and providing artificial intelligence system operations and interfaces via a workload management engine in an artificial intelligence system. The workload management operations are a solution to a specific problem (e.g., limited flexibility in NPU's capacity to adapt to diverse workloads, hindering their ability to handle a broad range of applications effectively causing suboptimal inference speeds, leading to delays in real-time processing tasks) in an artificial intelligence system. The workload management engine provides ordered combination of operations that incorporates adaptive strategies that adjust the neural network models employed by the NPU based on the dynamic nature of workloads and workload management factors-which improves computing operations in an artificial intelligence system.

In this way, the workload management engine provides a technical improvement in AI technology especially improving prioritization and management of neural network models on a process. The workload management engine involves integration of neural network models with processor optimization, providing a technical solution that goes beyond abstract ideas—for example, a workload management logic provides a prioritization algorithm and decisions rules to performing processor optimization. The processor optimization leads to efficiency gains in managing the plurality of neural network including efficient allocation of resources including: processing power and memory for improved task execution. Moreover, optimization techniques are specifically adapted to unique characteristics of neural network models (e.g., full neural networks and reduced neural networks; different reduction strategies; different tasks and task priorities) to address challenges inherent to processors, which can be distinguished from generic optimization methods.

### Example Systems and Operations

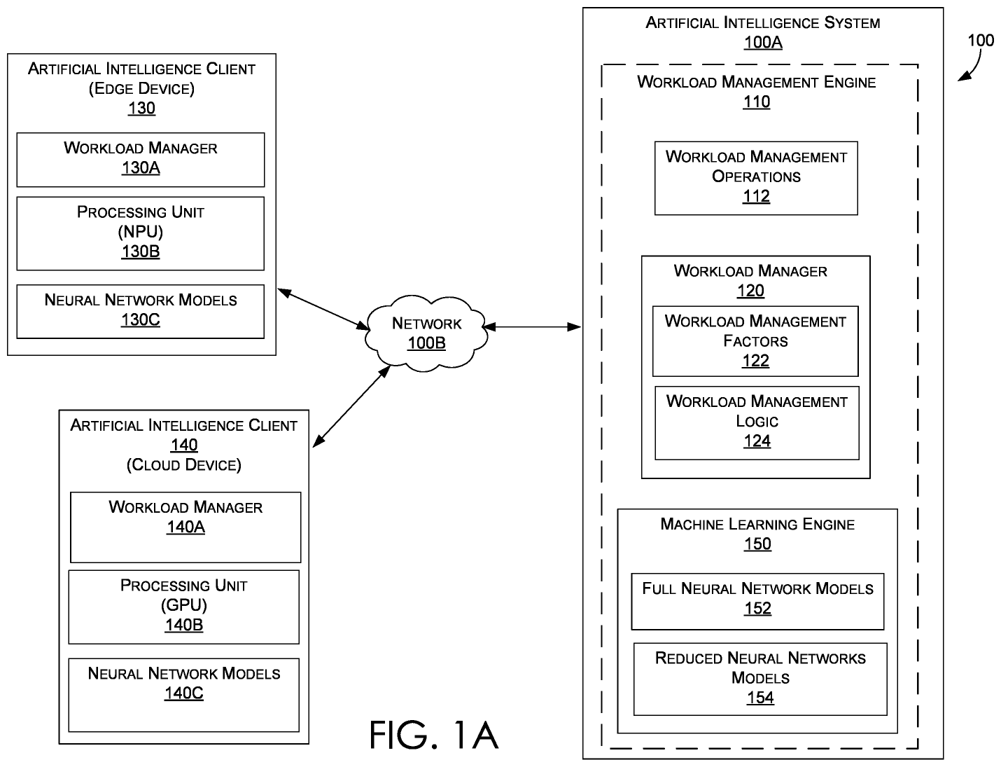

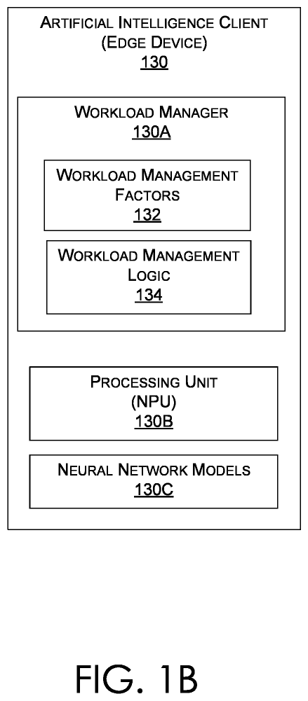

Aspects of the technical solution can be described by way of examples and with reference to FIGS. 1A-1B. FIG. 1A illustrates a cloud computing system (environment) 100 including artificial intelligence system 100A; network 100B; workload management engine 110, workload management operations 112, workload manager 120 including workload management factors 122 and workload management logic 124; artificial intelligence client 130 (e.g., edge device) including workload manager 130A, processing unit 130B, neural network models 130C, artificial intelligence client 140 (e.g., cloud device) including workload manager 140A, processing unit 140B, neural network models 140C; and machine learning engine 150 including full neural network models 152 and reduced neural network models 154.

The cloud computing environment 100 provides computing system resources for different types of managed computing environments. For example, the cloud computing environment 100 supports delivery of computing services-including servers, storage, databases, networking, software synthesis applications and services collectively “service(s)”, and artificial intelligence system (e.g., artificial intelligence system 100A). A plurality of artificial intelligence clients (e.g., artificial intelligence client 130) include hardware or software that access resources in the cloud computing environment 100. Artificial intelligence client 130 can include an application or service that supports client-side functionality associated with cloud computing environment 100. The plurality of artificial intelligence clients can access computing components of the cloud computing environment 100 via a network (e.g., network 100B) to perform computing operations.

Artificial intelligence system 100A is responsible for providing an artificial intelligence computing environment or architecture that includes the infrastructure and components that support the development, training, and deployment of artificial intelligence models. Artificial intelligence system 100A is responsible for providing workload management associated with workload management engine 110. Artificial intelligence system 100A operates to support generating inferences for machine learning models.

Artificial intelligence system 100A provides a workload management engine 110 that supports dynamically selecting different neural network models (e.g., a plurality of neural network models) to provide workload management on processing units (e.g., an NPU). The workload management engine 110 can support a preparation phase that prepares and deploys a plurality of neural network models and a runtime phase for that supports dynamically switching the plurality of neural network models at processing units. For example, the plurality of neural network models may be deployed in artificial intelligence clients (e.g., artificial intelligence client 103 and artificial intelligence device 140) to support runtime operations via a workload manager (e.g., workload manager 130A and workload manager 140A) on corresponding artificial intelligence clients. The workload management engine 110 can provide a machine learning engine (e.g., machine learning engine 150) that supports providing a plurality of neural networks (e.g., full neural network models 152 and reduced neural network models).

Machine learning engine 150 is a machine learning framework or library that operates as a tool for providing infrastructure, algorithms, capabilities for designing, training, and deploying machine learning models. The machine learning engine 150 can include pre-built functions and APIs that enable building and applying machine learning techniques. The machine learning engine 150 can provide a machine learning workflow from data processing and feature extraction to model training, evaluation, and deployment.

The machine learning engine 150 trains the plurality of neural network models (e.g., a plurality of neural network models) that include different versions a full neural network model and different versions of a reduced neural network model. The plurality of neural network models can be train with different neural network model optimization (e.g., neural network reducing strategies). For example, the plurality of neural networks can be reduced based on quantization, pruning, or a network architecture selection. Quantization, a model compression technique, reduces the precision of numerical representations in neural networks, diminishing them to lower bit widths like 16-bit or 8-bit integers. This results in more compact models, reduced memory needs, and expedited inference with a graceful degradation in accuracy. Pruning involves selectively removing less crucial connections or neurons during training, producing sparser models with fewer parameters, diminished memory footprints, and potentially accelerated inference times. Network architecture selection encompasses tailoring or choosing neural network architectures that strike a balance between complexity and task performance, often favoring simplicity for efficient resource use and streamlined deployment. Transfer learning, involving the fine-tuning of pre-trained models for specific tasks, represents another facet of architecture selection. The machine learning engine 150 provides the plurality of models that are deployed to different types of artificial intelligence clients (e.g., edge devices or cloud devices).

The preparation phase can further include the workload management engine 110 associating workload management factors (e.g., workload management factors 122) and workload management logic (e.g., workload management logic 124). Workload management factors can include operational factors that determine the functioning and performance optimization of a processing unit. For example, the workload management factors can include physical environment conditions, operational mode, battery life, power mode, power supply mode, processor active capacity, task priority, and neural network model priority. The workload management logic refers to the set of rules, algorithms, and strategies implemented to optimize a processing unit. For example, the workload management logic is used to determine what to do for an active neural network model and a subsequent neural network model—as discussed herein in more detail. As such, the workload management engine accesses the plurality neural network models and associates the plurality of neural network models with corresponding workload management factors 122 and work and workload management logic 124.

The workload management engine deploys the plurality of neural network model to support workload management that includes dynamically switching between the plurality of neural network models based on the workload management factors 122 and the workload management logic 124. The plurality of neural network models can be deployed to different operating scenarios (e.g., edge device or cloud computing applications). By way of illustration, Convolutional Neural Networks (CNNs) are well-suited for visual tasks like image classification, object detection in autonomous driving, and medical image analysis. They excel in capturing spatial patterns. Recurrent Neural Networks (RNNs), on the other hand, are effective in sequence-based tasks. They find applications in natural language processing for tasks like language modeling and sentiment analysis, time series prediction in finance, speech recognition, and gesture recognition in human-computer interaction. CNNs focus on visual data and spatial relationships, while RNNs specialize in processing sequential and temporal information, showcasing their versatility in different machine learning applications. Other variations of neural network models and scenarios are contemplated with embodiments of the present technical solution.

The workload management engine 110 provides a workload manager 120 that manages the execution of neural network tasks. The workload manager 120 is responsible for optimizing the utilization of the processing unit's computational resources, ensuring that neural network workloads are processed efficiently. In particular, the workload manager 120 causes tasks associated with an artificial intelligence client to be executed with a selected neural network model. The workload manager 120 can include workload management factors 122 and workload management logic 124 that support workload management at an artificial intelligence client.

As shown, the workload manager 120 is deployed in the cloud; however, the workload manager 120 can be deployed to different types of devices to support the functionality described herein. In particular, the workload manager 120 can be deployed in different devices and applications to provide workload management functionality described herein. For example, artificial intelligence client 130 can be an edge device that includes workload manger 130A, a processing unit 130B (e.g., NPU) and neural network models 130C (e.g., a neural network models from machine learning engine 150). Artificial intelligence client 140 can be a remote or local cloud device or application that includes workload manager 140, a processing unit 140B (e.g., GPU) and neural network models 140C (e.g., a neural network models from machine learning engine 150). The workload manager 140A provides similar functionality as workload manager 130A for artificial intelligence client 140 (e.g., a cloud device).

FIG. 1B illustrates artificial intelligence client 130 with workload manager 130A with workload management factors 132, workload management logic 134, processing unit 130B, and neural network models 130C. By way of example, artificial intelligence client 130 can refer to an exemplary edge device that supports implementation of a plurality of neural networks. The edge device can be a smart security camera designed for multifaceted functionalities. Equipped with Neural Processing Units (NPUs) (e.g., processing unit 130B) the edge device can execute machine learning tasks concurrently via neural network models 130C. One neural network model can be dedicated to object detection, for identifying and classifying various entities within the camera's scope. Simultaneously, another neural network model specializes in facial recognition, enabling the camera to identify and authenticate individuals. Additionally, a third neural network model focuses on anomaly detection, discerning irregular patterns or unexpected events for enhanced security.

The workload manager 130A is associated with the processing unit 130B to support dynamically switching between the plurality of neural network models based on the workload management factors 132 and a workload management logic 134. Processing unit 130 (or workload processing units), can be Neural Processing Units (NPUs) or other processing unit (e.g., Graphics Processing Units (GPUs), and Tensor Processing Units (TPUs)) that are specialized hardware components designed to accelerate computational tasks in electronic devices. NPUs are tailored for neural network operations, efficiently executing parallelized tasks like matrix multiplication and tensor computations.

Workload management factors 132 can include operational factors that determine the functioning and performance optimization of a processing unit. For example, the workload management factors 132 can include physical environment conditions, operational mode, battery life, power mode, power supply mode, processor active capacity, task priority, and neural network model priority. The workload management logic 134 refers to the set of rules, algorithms, and strategies implemented to optimize a processing unit. Applying the workload management logic 134 for a processing unit 130B involves observing distinct workload management factors 132 associated with various neural network models (e.g., full neural network model, a first, a second, and a third reduced neural network model). The workload management logic 134 can be associated a first priority type (e.g., a set of priority identifiers: critical, high, medium, low) associated with task; and a second priority types (e.g., a set of priority identifiers: high, medium, low) associated the plurality of neural network models. In this way, both priority types can be employed for determining which neural network model to select.

The artificial intelligence client 130 includes neural network models 130C. Each neural network model possesses unique features—for example, a first reduced neural network model is reduced based on quantization, a second reduced neural network model is reduced based on quantization, and a third reduced neural network model is reduced based on NAS. The neural networks are selectively selected based on workload management factors 132 and workload management logic 134 to optimize processing unit 130B performance.

As such, in operation, the workload manager 130A identifies a plurality of states of workload management factors. The workload manager 130A identifies a task associated with processing unit 130B. Based on the task and the plurality of states of the workload management factors, the workload manager 130A selects a neural network model from the neural network models 130C. The workload manager 130A causes the task to be executed on the processing unit 134 using the selected neural network model

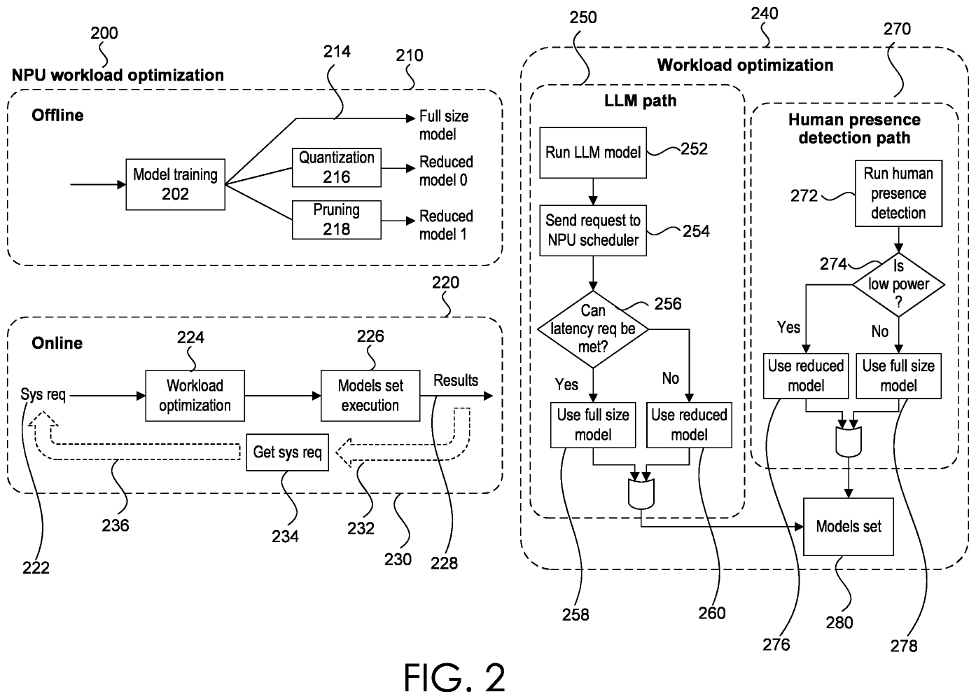

With reference to FIG. 2, FIG. 2 illustrates an example implementation of the workload management engine for NPU workload optimization 200. The workload management engine provides offline model training 212 that supports training a plurality of neural network models. Model training 202 can support full size model training 214 for a full size model, training with quantization 216 for reduced model 0, and training with pruning for reduced model 1.

As discussed herein, the plurality of neural network models can be associate with workload management factors and workload management logic. The workload management engine can further support online workload optimization, for example, using a workload manager and a workload scheduler. During a preparation phase, the offline training of neural network models is performed. Training can include training full neural network models and reduced neural network models-using reduction strategies. Quantization includes training a reduced neural network model that gets as close as possible to the original performance of a full neural network model, which saving memory and power (e.g., less cycles to make inferences). Pruning includes training a reduced neural network model using several different techniques (e.g., reducing weights, removing arcs from graphs, employing degrees of pruning). Network architecture can include reducing neural network size with different configurations of a full neural network model, where different reduced neural network sizes can be selectively implemented. It is contemplated that different types of reduction strategies can be combined to support training a reduced neural network model.

Trained models can be associated with workload management logic provides decision rules for choosing between the neural network models. For example, the decision rules can be associated with workload management factors (e.g., latency, power consumption, power mode). The workload management logic can vary, for example, associated with physical conditions (e.g., user presence for facial detection), software feature (e.g., always on mode), or hardware features (e.g., NPU memory capacity) of a processing unit (e.g., NPU). The workload management logic can implement priorities for different workload management factors including priority of the type of neural network, the type of tasks, and the type of factors. For example, a first set of priorities can employed when the power supply is connected and second set of priorities applied when the power supply is disconnected.

During a runtime phase, the runtime phase can include an initiation mechanism (e.g., event trigger, time loop, state change) that is used to call a trigger input associated with initiating the runtime phase. The runtime phase supports dynamically switching from a current neural network model to a selected subsequent neural network model. A system request 222, for example, a system request associated with observing workload management factors can trigger workload optimization 224. Workload optimization 224 can include accessing workload management factors and employing workload management logic to select one or more neural network models. Models set execution 226 can include a processor unit (e.g., NPU) executing the one or more neural network models. The results 228 (e.g., performance metrics) associated with executing the one or more neural networks can be generated. It is contemplated that feedback mechanism 230 can be implemented, such that, the results 228 are communicated and based on evaluating the results 228 and subsequent workload management factors, another system request 234 can be generated and communicated 236 to dynamically switch an active neural network model to a subsequent neural network model.

Workload optimization 240 can include an LLM path 250 and a human presence detection path 270. The LLM path 250 can be associated with a first set of neural network models (e.g., a first full neural network model and a first reduced neural network model) for the LLM tasks. The human presence detection path 270 can be associated with a second set of neural network models (e.g., a second full neural network model and a second reduced neural network model) for the human presence detection task.

At block 252, the LLM path 250 includes running the LLM model (e.g., executing the LLM tasks on the LLM model); and at block 254, sending the request to the NPU scheduler. The NPU scheduler can evaluate whether to use a reduced neural network model. For example, the request can be associated with a high priority task that can tolerate only a limited amount of latency (e.g., compare a word document auto-complete that should happen in real-time to a ChatGPT response that can tolerate some delay). At block 256, a determination is made (e.g., using a workload management logic) whether a latency requirement can be met. And at block 268, the first full neural network is employed if the latency requirement can be met; and at block 260, the first reduced neural network model is employed.

At block 272, the human presence detection path includes running human presence detection; and at block 274, and then determining if the device power is low; at block 276, if it is determined that the device power is low, the second full neural network model is employed and at block 278, if it is determined that the device power is not low, then the second neural network model is employed. At block 280, the output neural network models from the LLM path 250 and the human presence detection path 270 are executed at the NPU.

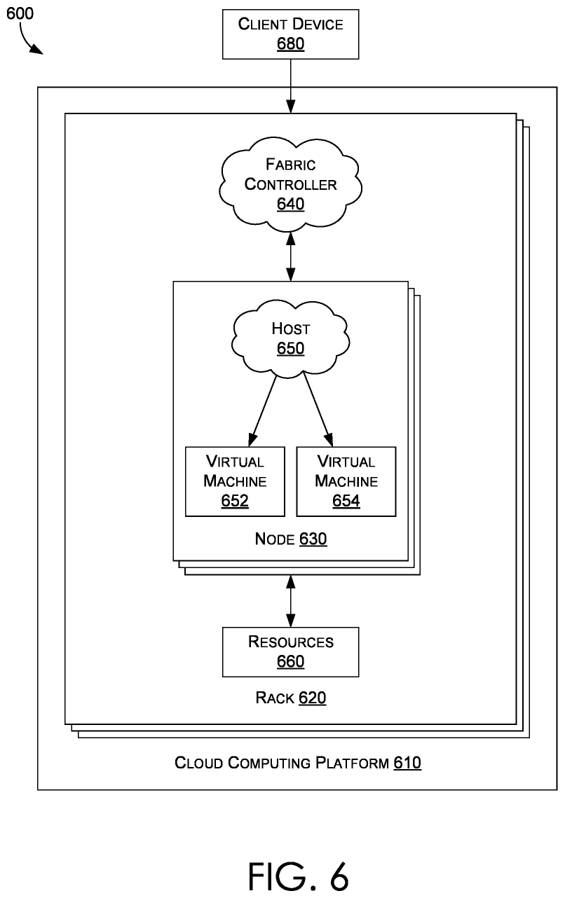

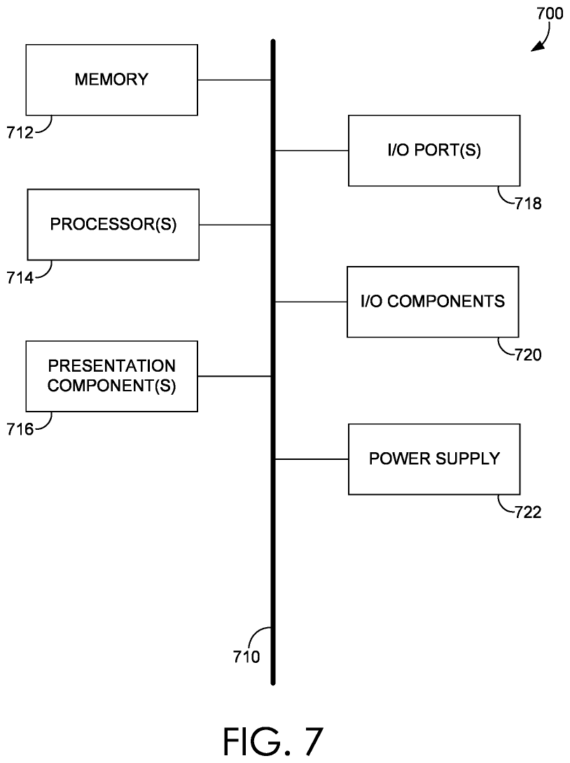

Aspects of the technical solution have been described by way of examples and with reference to FIGS. 1A, 1B and 2. FIG. 1A is a block diagram of an exemplary technical solution environment, based on example environments described with reference to FIGS. 6 and 7 for use in implementing embodiments of the technical solution are shown. Generally the technical solution environment includes a technical solution system suitable for providing the example artificial intelligence system 100A in which methods of the present disclosure may be employed. Among other engines, managers, generators, selectors, or components not shown (collectively referred to herein as “components”), the technical solution environment of artificial intelligence system 100A corresponds to FIG. 1A and FIG. 1B. FIG. 2A illustrates offline model training associated with artificial intelligence system 100A and online optimization associated with an artificial intelligence client 130 (e.g., edge device) including two example use cases.

### Example Methods

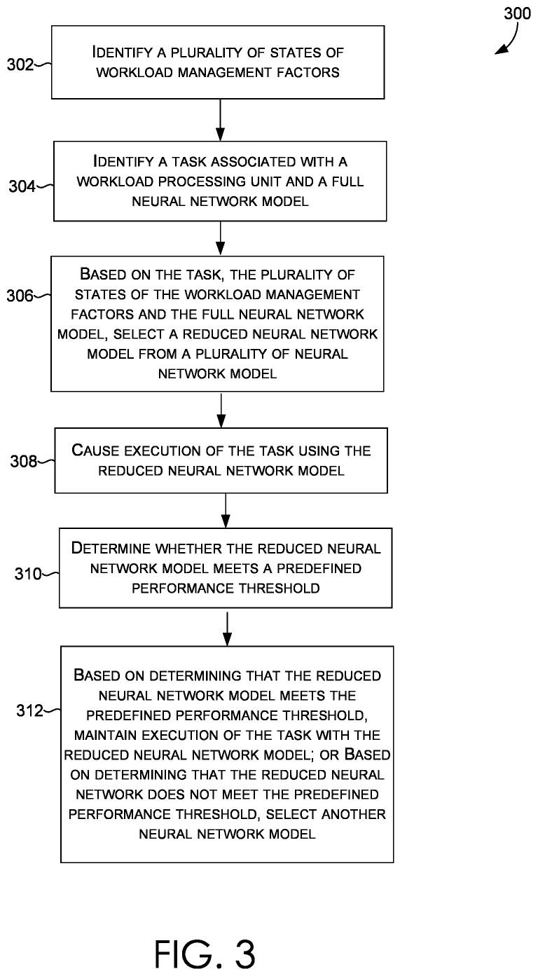

With reference to FIGS. 3, 4, and 5, flow diagrams are provided illustrating methods for providing workload management using a workload management engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system or computing system).

Turning to FIG. 3, a flow diagram is provided that illustrates a method 300 for providing workload management using a workload management engine in an artificial intelligence system. At block 302, the workload management engine identifies a plurality of states of workload management factors. Workload management factors are predefined operational factors that support managing performance optimization of workload processing units. At block 304, the workload management engine identifies a task associated with a workload processing unit and a full neural network model. At block 306, based on the task, the plurality of states of the workload management factors, and the full neural network model, the workload management engine selects a reduced neural network model from a plurality neural network models. At block 308, the workload management engine causes execution of the task using the reduced neural network model. At block 310, the workload management engine determines whether the reduced neural network model meets a predefined performance threshold. At block 312, based on determining that the reduced neural network model meets the predefined performance threshold, the workload management engine maintains execution of the task with the reduced neural network model; or based on determining that the reduced neural network model does not meet the predefined performance threshold, the workload management engine selects another neural network model.

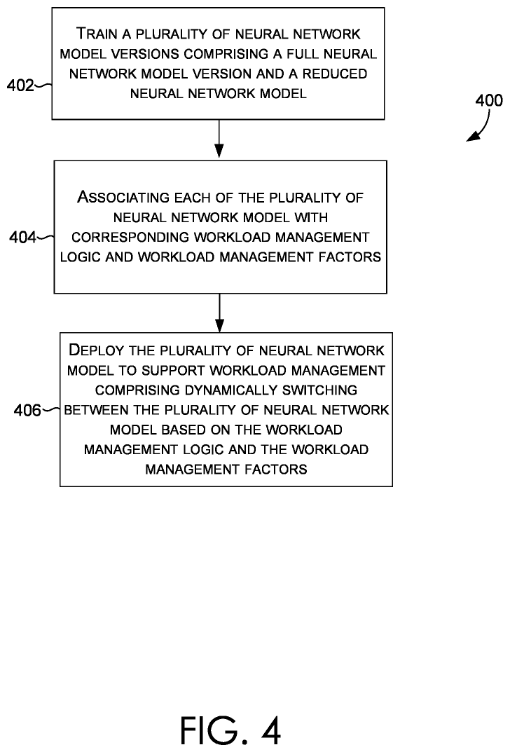

Turning to FIG. 4, a flow diagram is provided that illustrates a method 400 for providing workload management using a workload management engine in an artificial intelligence system. At block 402, the workload management engine trains a plurality of neural network models comprising a full neural network model and a reduced neural network model. At block 404, the workload management engine associates each of the plurality of neural network models with corresponding workload management logic and workload management factors. At block 406, the workload management engine identifies deploys the plurality of neural network models to support workload management comprising dynamically switching between the plurality of neural network models based on the workload management logic and the workload management factors.

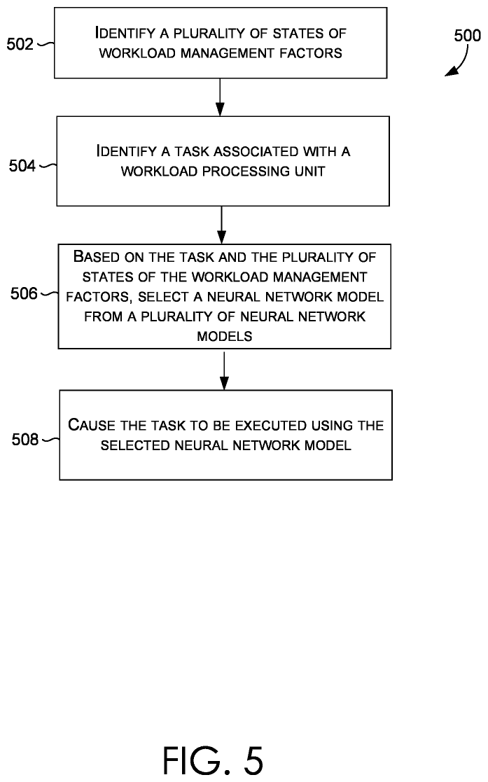

Turning to FIG. 5, a flow diagram is provided that illustrates a method 500 for providing workload management using a workload management engine in an artificial intelligence system. At block 502, the workload management engine identifies a plurality of states of workload management factors. Workload management factors are predefined operational factors that support performance optimization of workload processing units. At block 504, the workload management engine identifies a task associated with a workload processing unit. At block 506, based on the task and the plurality of states of the workload management factors, the workload management engine selects a neural network model from a plurality neural network models. At block 508, the workload management engine causes the task to be executed using the selected neural network model.

### Other Embodiments

In some embodiments, a system, such as the computerized system described in any of the embodiments above, comprises at least one computer processor and computer storage media storing computer-useable instructions that, when used by the at least one computer processor, cause the system to perform operations. The operations comprise identifying a plurality of states of workload management factors. The workload management factors are predefined operational factors that support managing performance optimization of workload processing units. The operations further comprise identifying a task associated with a workload processing unit and a full neural network model from a plurality of neural network models. The operations comprise based on the task, the plurality of states of the workload management factors, and the full neural network model, selecting a reduced neural network model from the plurality of neural network models. The operations further comprise causing execution of the task using the reduced neural network model. The operations also comprise determining whether the reduced neural network model meets a predefined performance threshold. And, the operations comprise based on determining that the reduced neural network meets the predefined performance threshold, maintaining execution of the task with the reduced neural network model; or based on determining that the reduced neural network does not meet the predefined performance threshold, selecting another neural network model from the plurality of neural network models.

In any combination of the above embodiments of the system, a workload manager is associated with the workload processing unit to support dynamically switching between the plurality of neural network models based on the workload management factors and a workload management logic.

In any combination of the above embodiments of the system, the workload management logic is associated with a first priority type associated with the task and a second priority type associated with the plurality of neural network models.

In any combination of the above embodiments of the system, selecting the neural network model from the plurality of neural network models comprises selecting another reduced neural network model or reverting to the full neural network model.

In any combination of the above embodiments of the system, the operations further comprise identifying as second full neural network model for optimization of the workload processing unit, wherein the workload processing unit supports the full neural network model and the second full neural network model simultaneously, the full neural network model having a higher optimization priority than the second full neural network model.

In any combination of the above embodiments of the system, the plurality of neural network models include a first full neural network model associated with at least two corresponding reduced neural network models and a second full neural network model associated with at least two corresponding reduced neural network models.

In any combination of the above embodiments of the system, the workload processing unit is associated with one of the following: an edge device or a cloud computing application.

In any combination of the above embodiments of the system, the workload processing unit corresponds to one of the following: a Neural Processing Unit (NPU), a Graphics Processing Units (GPU), or a Tensor Processing Units (TPU).

In any combination of the above embodiments of the system, the operations further comprise training the plurality of neural network models comprising the full neural network model and the reduced neural network model. Each of the plurality of neural network models is associated with corresponding workload management logic and workload management factors. The plurality of neural network models are deployed to support workload management comprising dynamically switching between the plurality of neural network models based on their corresponding workload management logic and workload management factors.

In any combination of the above embodiments of the system, training the plurality of neural network models comprises training the full neural network model and training a plurality of reduced neural network models, wherein reducing the reduced neural network model is based on one of the following: quantization, pruning, or network architecture selection (NAS).

In some embodiments, one or more computer-storage media having computer-executable instructions embodied thereon that, when executed by a computing system having a processor and memory, cause the processor to perform operations. The operations comprising training a plurality of neural network models comprising a full neural network model and a reduced neural network model. The operations also comprise associating each of the plurality of neural network models with corresponding workload management logic and workload management factors, wherein workload management factors are predefined operational factors that support managing performance optimization of workload processing units. And the operations comprises deploying the plurality of neural network models to support workload management comprising dynamically switching between the plurality of neural network models based on the their corresponding workload management logic and workload management factors.

In any combination of the above embodiments of the media, training the plurality of neural network models comprises training the full neural network model and training a plurality of reduced neural network models, wherein reducing the reduced neural network model is based on one of the following: quantization, pruning, or network architecture selection (NAS).

In any combination of the above embodiments of the media, the plurality of neural network models include a first full neural network model associated with at least two corresponding reduced neural network models and a second full neural network model associated with at least two corresponding reduced neural network models.

In any combination of the above embodiments of the media, each of the at least two corresponding reduced neural network models of the first full neural network model are associated with a different reduction strategy.

In any combination of the above embodiments of the media, the operations comprise identifying a plurality of states of workload management factors; identifying a task associated with a workload processing unit; based on the task and the plurality of states of the workload management factors, selecting a neural network model from a plurality of neural network models; and causing the task to be executed using the selected neural network model.

In some embodiments, a computer-implemented method is provided. The method comprises identifying a plurality of states of workload management factors, where workload management factors are predefined operational factors that support managing performance optimization of workload processing units. The method also comprises identifying a task associated with a workload processing unit. The method further comprises based on the task and the plurality of states of the workload management factors, selecting a neural network model from a plurality of neural network models. And the method comprises causing the task to be executed using the selected neural network model.

In any combination of the above embodiments of the method, the workload manager is associated with the workload processing unit to support dynamically switching between the plurality of neural network models based on the workload management factors and a workload management logic.

In any combination of the above embodiments of the method, the method further comprises determining whether the neural network model meets a predefined performance threshold; and based on determining that the neural network model meets the predefined performance threshold, maintaining execution of the task with the reduced neural network model.

In any combination of the above embodiments of the method, the method comprises determining whether the neural network model meets a predefined performance threshold; and based on determining that the neural network model does not meet the predefined performance threshold, selecting another neural network model from the plurality of neural network models.

In any combination of the above embodiments of the method, the method comprises the neural network is a reduced neural network; and selecting another neural network model from the plurality of neural network models comprises selecting another reduced neural network model.

### Technical Improvement

Embodiments of the present technical solution have been described with reference to several inventive features (e.g., operations, systems, engines, and components) associated with an artificial intelligence system. Inventive features described include: operations, interfaces, data structures, and arrangements of computing resources associated with providing the functionality described herein relative with reference to a workload management engine. Functionality of the embodiments of the present technical solution have further been described, by way of an implementation and anecdotal examples—to demonstrate that the operations (e.g., dynamically switching between different neural network models for optimized performance). The workload management engine is a solution to a specific problem (e.g., limited flexibility in NPU/GPU/TPU) capacity to adapt to diverse neural network architectures and workloads, hindering their ability to handle a broad range of applications effectively causing suboptimal inference speeds, leading to delays in real-time processing tasks) in artificial intelligence technology. An adaptive strategy framework improves computing operations associated with providing workload management using a workload management engine of an artificial intelligence system. Overall, these improvements result optimized computation, memory, and increased flexibility in artificial intelligence systems when compared to previous conventional artificial intelligence system operations performed for similar functionality.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing platform 610 in a data center can be configured to host and support operation of endpoints of a particular service application. Cloud computing platform 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 700 described with reference to FIG. 7, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 7 in particular, an example operating environment for implementing embodiments of the present technical solution is shown and designated generally as computing device 700. Computing device 700 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. It is recognized that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
identifying a plurality of states of workload management factors, wherein workload management factors are predefined operational factors that support managing performance optimization of workload processing units;
identifying a task associated with a workload processing unit and a full neural network model from a plurality of neural network models;
based on the task, the plurality of states of the workload management factors, and the full neural network model, selecting a reduced neural network model from the plurality of neural network models;
causing execution of the task using the reduced neural network model;
determining whether the reduced neural network model meets a predefined performance threshold; and
based on determining that the reduced neural network meets the predefined performance threshold, maintaining execution of the task with the reduced neural network model; or
based on determining that the reduced neural network does not meet the predefined performance threshold, selecting another neural network model from the plurality of neural network models.

2. The system of claim 1, wherein a workload manager is associated with the workload processing unit to support dynamically switching between the plurality of neural network models based on the workload management factors and a workload management logic.

3. The system of claim 1, wherein the workload management logic is associated with a first priority type associated with the task and a second priority type associated with the plurality of neural network models.

4. The system of claim 1, wherein selecting the neural network model from the plurality of neural network models comprises selecting another reduced neural network model or reverting to the full neural network model.

5. The system of claim 1, further comprising identifying as second full neural network model for optimization of the workload processing unit, wherein the workload processing unit supports the full neural network model and the second full neural network model simultaneously, the full neural network model having a higher optimization priority than the second full neural network model.

6. The system of claim 1, wherein the plurality of neural network models include a first full neural network model associated with at least two corresponding reduced neural network models and a second full neural network model associated with at least two corresponding reduced neural network models.

7. The system of claim 1, wherein the workload processing unit is associated with one of the following: an edge device or a cloud computing application.

8. The system of claim 1, wherein the workload processing unit corresponds to one of the following: a Neural Processing Unit (NPU), a Graphics Processing Units (GPU), or a Tensor Processing Units (TPU).

9. The system of claim 1, the operations comprising:
training the plurality of neural network models comprising the full neural network model and the reduced neural network model;
associating each of the plurality of neural network models with corresponding workload management logic and workload management factors; and
deploying the plurality of neural network models to support workload management comprising dynamically switching between the plurality of neural network models based on their corresponding workload management logic and workload management factors.

10. The system of claim 1, wherein training the plurality of neural network models comprises training the full neural network model and training a plurality of reduced neural network models, wherein reducing the reduced neural network model is based on one of the following: quantization, pruning, or network architecture selection (NAS).

11. One or more computer-storage media having computer-executable instructions embodied thereon that, when executed by a computing system having a processor and memory, cause the processor to perform operations, the operations comprising:
training a plurality of neural network models comprising a full neural network model and a reduced neural network model;
associating each of the plurality of neural network models with corresponding workload management logic and workload management factors, wherein workload management factors are predefined operational factors that support managing performance optimization of workload processing units; and
deploying the plurality of neural network models to support workload management comprising dynamically switching between the plurality of neural network models based on the their corresponding workload management logic and workload management factors.

12. The media of claim 11, wherein training the plurality of neural network models comprises training the full neural network model and training a plurality of reduced neural network models, wherein reducing the reduced neural network model is based on one of the following: quantization, pruning, or network architecture selection (NAS).

13. The media of claim 11, wherein the plurality of neural network models include a first full neural network model associated with at least two corresponding reduced neural network models and a second full neural network model associated with at least two corresponding reduced neural network models.

14. The media of claim 13, wherein each of the at least two corresponding reduced neural network models of the first full neural network model are associated with a different reduction strategy.

15. The media of claim 11, the operations further comprising:
identifying a plurality of states of workload management factors;
identifying a task associated with a workload processing unit;
based on the task and the plurality of states of the workload management factors, selecting a neural network model from a plurality of neural network models; and
causing the task to be executed using the selected neural network model.

16. A computer-implemented method, the method comprising:
identifying a plurality of states of workload management factors, wherein workload management factors are predefined operational factors that support managing performance optimization of workload processing units;
identifying a task associated with a workload processing unit;
based on the task and the plurality of states of the workload management factors, selecting a neural network model from a plurality of neural network models; and
causing the task to be executed using the selected neural network model.

17. The method of claim 16, wherein the workload manager is associated with the workload processing unit to support dynamically switching between the plurality of neural network models based on the workload management factors and a workload management logic.

18. The method of claim 16, the method further comprising:
determining whether the neural network model meets a predefined performance threshold; and
based on determining that the neural network model meets the predefined performance threshold, maintaining execution of the task with the reduced neural network model.

19. The method of claim 16, the method further comprising:
determining whether the neural network model meets a predefined performance threshold; and
based on determining that the neural network model does not meet the predefined performance threshold, selecting another neural network model from the plurality of neural network models.

20. The method of claim 19, wherein the neural network is a reduced neural network; and
wherein selecting another neural network model from the plurality of neural network models comprises selecting another reduced neural network model.
